(19) United States
(12) Patent Application Publication
(10) Pub. No.: US 2008/0084383 A1
(43) Pub. Date: Apr. 10, 2008

(54) Controller having pointing module

(75) Inventors: I-Hau Yeh, Hsinchu City (TW); Jia-Yih Li, Taichung City (TW)

Correspondence Address: TROXELL LAW OFFICE PLLC, 5205 LEESBURG PIKE, SUITE 1404, FALLS CHURCH, VA, 22041, US

(73) Assignee: ELAN MICROELECTRONICS CORP., Hsinchu City (TW)

(21) Appl. No.: 11/603,114

(22) Filed: Nov. 22, 2006

(30) Foreign Application Priority Data
Oct. 5, 2006 (TW) 095137160

(51) Int. Cl. G09G 5/00

(52) U.S. Cl. 345/156

(57) ABSTRACT

A controller uses a a pointing stick to move a cursor on an electrical device. By using the pointing stick, the controller is minimized in size and is light-weighted. And energy is saved too.

### FIELD OF THE INVENTION

The present invention relates to a controller; more particularly, relates to using a pointing module of a pointing stick in the controller.

### DESCRIPTION OF THE RELATED ARTS

A general remote controller (RC) is a pointing device having five directional keys or nine directional keys. But a directional key is a mechanical key and its moving direction is limited, which is only suitable for menu selection. Hence, it is quite in convenient to be used in a multi-media application for positioning and moving a pointer.

Or, a controller may be add ed with a touch pad to simulate pointing action of a mouse. But its control area is limited owing to the size of the controller, which is quite inconvenient to move for a long distance.

A prior art in Taiwan, as shown in FIG. 3, is called, “Intelligent remote control device.” The intelligent remote control device 3 is used to control an electrical device. The electrical device has a communication module to communicate with the intelligent remote control device 3. The intelligent remote control device 3 comprises a key pad 31 to operate the intelligent remote control device 3; a display panel 32 to display data; a transmit port 33 to couple to the communication module of the electrical device; and a control unit 34 to sent commands to the electrical device through the transmit port 33 and the coupling of the communication module. A command set is sent from the communication module of the electrical device to be displayed on the display panel 33; and then the key pad is used to select a command from the command set on the display panel 32 to control the electrical device. Therein, the controller has a command database 35 to store the command set of the electrical device.

Although the above prior arts use controllers to control electrical devices, the prior arts do not control pointer exquisitely. A mouse or any parallel device is additionally required to finely control a pointer. Hence, the prior arts do not fulfill users' requests on actual use.

### SUMMARY OF THE INVENTION

The main purpose of the present invention is to use a pointing module of a pointing stick in a controller to minimize and light-weight a controller and to save energy.

To achieve the above purpose, the present invention is a controller having a pointing module, comprising a key module, a pointing module, a wireless communication module and a micro-processing module, where the micro-processing module controls the key module, the pointing module and the wireless communication module; the wireless communication module is connected with an electrical device having a wireless receiving unit; and a function is selected and a pointer is controlled through the key module and the pointing module. Accordingly, a novel controller having a pointing module is obtained.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1A is the structural view showing the first preferred embodiment according to the present invention;

FIG. 1B is the perspective view showing the first preferred embodiment;

FIG. 2A is the structural view showing the second preferred embodiment;

FIG. 2B is the perspective view showing the second preferred embodiment; and

FIG. 3 is the view of the prior art.

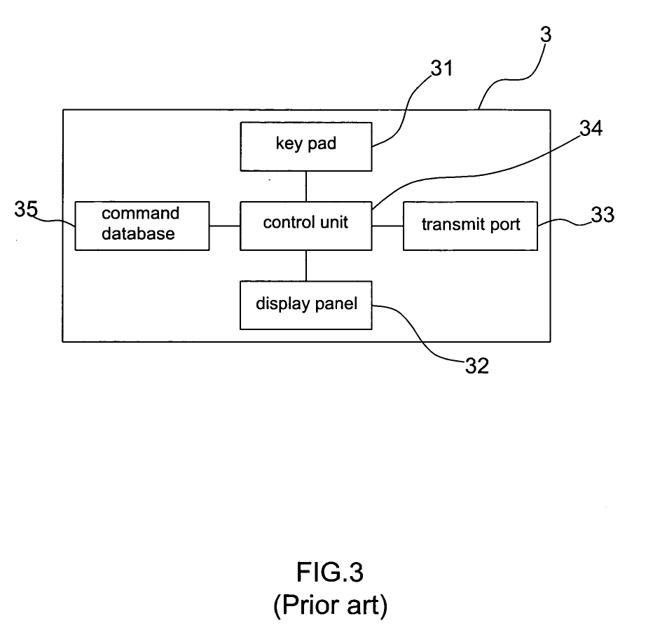

### DESCRIPTIONS OF THE PREFERRED EMBODIMENTS

The following descriptions of the preferred embodiments are provided to understand the features and the structures of the present invention.

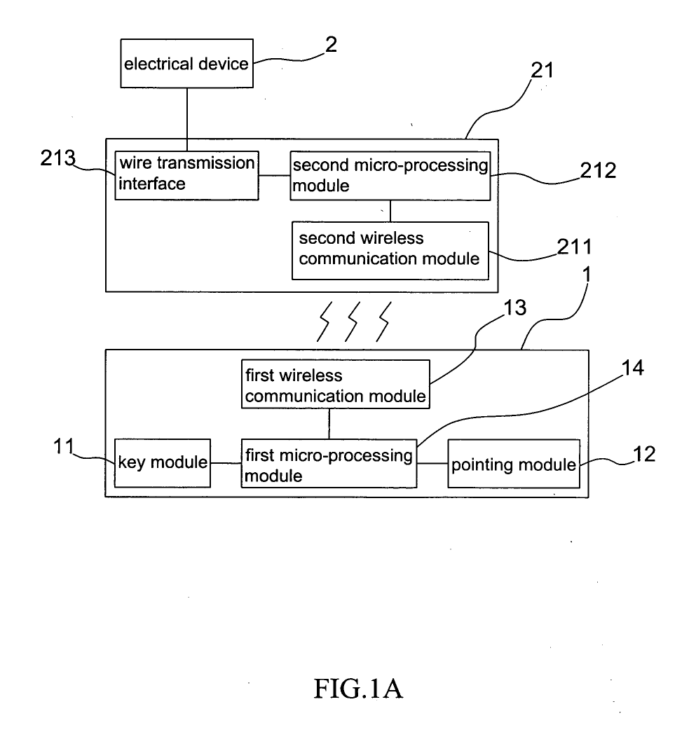

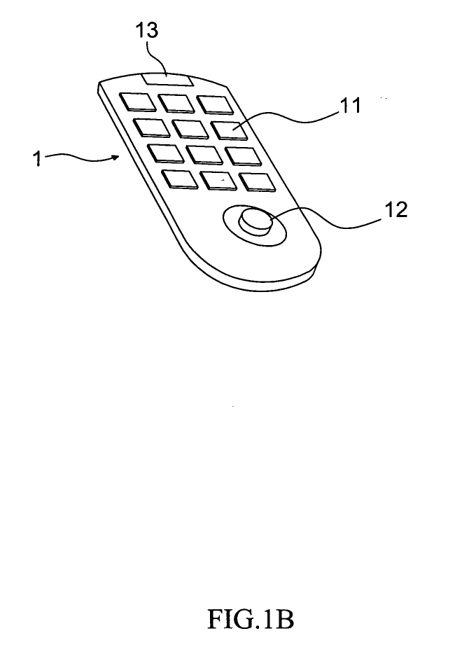

Please refer to FIG. 1A and FIG. 1B, which are a structural view and a perspective view showing the first preferred embodiment according to the present invention. As shown in the figures, the present invention is a controller having a pointing module, where the controller 1 comprises a key module 11, a pointing module 12, a first wireless communication module 13 and a first micro-processing module 14.

The controller 1 is connected with a wireless receiving unit 21 of an electrical device 2 through the first wireless communication module 13; the first micro-processing module 14 controls the key module 11, the pointing module 12 and the first wireless communication module 13; and, a function is selected and a pointer is control led on the electrical device 2 through the key module 11 and the pointing module 12. Therein, the pointing module 12 is a pointing stick; the first wireless communication module 13 is connected with the wireless receiving unit 21 of the electrical device through ultra violet, 27 MHz carrier, 2.4 GHz carrier and blue tooth; the wireless receiving unit 21 comprises a second wireless communication module 211, a second micro-processing module 212 and a wire transmission interface 213; and, the wire transmission interface is a universal serial bus (USB) interface or a universal asynchronous receiver transmitter (UART) interface and is connected with the electrical device 2.

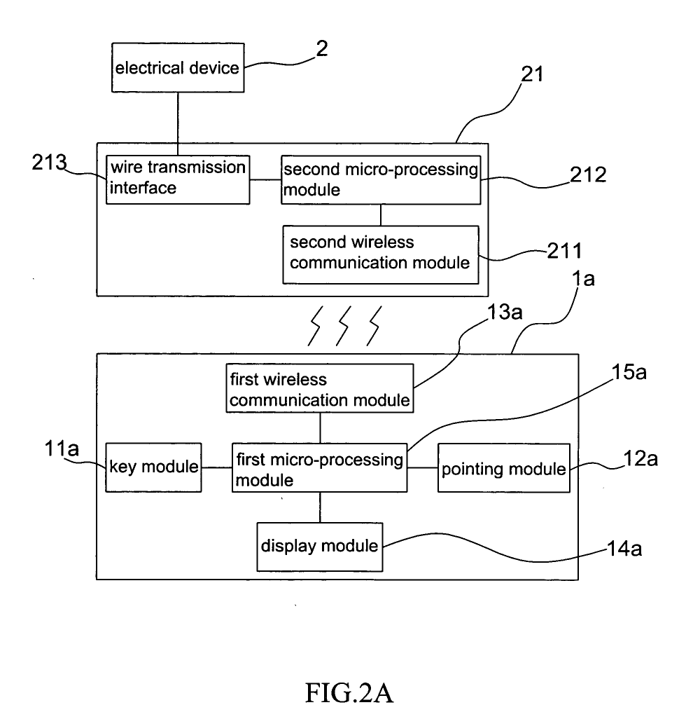

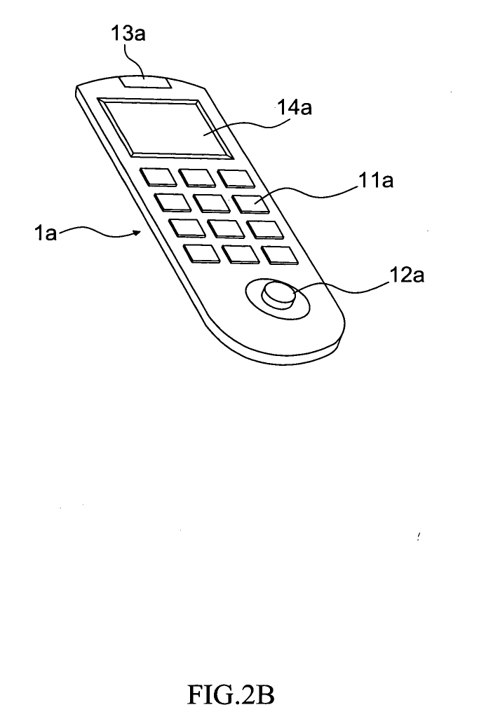

Please refer to FIG. 2A and FIG. 2B, which are a structural view and a perspective view showing the second preferred embodiment. As shown in the figures, the present invention is a controller having a pointing module, where the controller 1a comprises a key module 11a, a pointing module 12a, a first wireless communication module 13a, a display module 14a and a first micro-processing module 15a.

The controller 1a is connected with a wireless receiving unit 21 of an electrical device 2 through the first wireless communication module 13a; the first micro-processing module 15a controls the key module 11a, the pointing module 12a, the first wireless communication module 13a and the display module 14a; and, a function is selected and a pointer is controlled on the electrical device 2 through the key module 11a and the pointing module 12a. Therein, the pointing module 12a is a pointing stick; the first wireless communication module 13a is connected with the wireless receiving unit 21 of the electrical device through ultra violet, 27 MHz carrier, 2.4 GHz carrier and blue tooth; the display module 14a displays a remote control status; the wireless receiving unit 21 comprises a second wireless communication module 211, a second micro-processing module 212 and a wire transmission interface 213; and, the wire transmission interface is a USB interface or a UART interface and is connected with the electrical device 2.

To sum up, the present invention is a controller having a pointing module, where a pointing stick is used to lengthen its lifetime, to minimize its size, to move pointer instinctively and to save energy.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A controller having a pointing module, comprising:
a key module;
a pointing module, said pointing module being a pointing stick;
a first wireless communication module, said first wireless communication module connecting with an electrical device having a wireless receiving unit; and
a first micro-processing module, said first micro-processing module controlling said key module, said pointing module and said first wireless communication module,
wherein said key module and said pointing module select function and move pointer.

2. The controller according to claim 1,
wherein said first wireless communication module is a communication module using ultra violet, 27 megahertz (MHz) carrier, 2.4 gigahertz (GHz) carrier and blue tooth.

3. The controller according to claim 1,
wherein said wireless receiving unit comprises a second wireless communication module, a second micro-processing module and a wire transmission interface.

4. The controller according to claim 3,
wherein said second wireless communication module is a communication module using ultra violet, 27 MHz carrier, 2.4 GHz carrier and blue tooth.

5. The controller according to claim 3,
wherein said wire transmission interface is selected from a group consisting of a universal serial bus (USB) interface and a universal asynchronous receiver transmitter (UART) interface.

6. A controller having a pointing module, comprising:
a key module;
a pointing module, said pointing module being a pointing stick;
a display module, said display module showing a remote control status;
a first wireless communication module, said first wireless communication module connecting with an electrical device having a wireless receiving unit; and
a first micro-processing module, said first micro-processing module controlling said key module, said pointing module, said display module and said first wireless communication module,
wherein said key module and said pointing module select function and move pointer.

7. The controller according to claim 6,
wherein said first wireless communication module is a communication module using ultra violet, 27 MHz carrier, 2.4 GHz carrier and blue tooth.

8. The controller according to claim 6,
wherein said wireless receiving unit comprises a second wireless communication module, a second micro-processing module and a wire transmission interface.

9. The controller according to claim 8,
wherein said second wireless communication module is a communication module using ultra violet, 27 MHz carrier, 2.4 GHz carrier and blue tooth.

10. The controller according to claim 8,
wherein said wire transmission interface is selected from a group consisting of a USB interface and a UART interface.
